(19) United States
(12) Patent Application Publication
(10) Pub. No.: US 2017/0286934 A1
(43) Pub. Date: Oct. 5, 2017

(54) PAYWINDOWS

(71) Applicant: Qbeats Inc., New York, NY (US)

(72) Inventors: Illan Poreh, New York, NY (US); Artem Vinokhodov, New York, NY (US)

(21) Appl. No.: 15/478,390

(22) Filed: Apr. 4, 2017

Related U.S. Application Data
(60) Provisional application No. 62/318,553, filed on Apr. 5, 2016.

(51) Int. Cl. G06Q 20/12; G06Q 20/40; G06F 21/62; G06Q 30/02

(52) U.S. Cl. CPC G06Q 20/1235; G06Q 30/0245; G06Q 20/40; G06F 21/6209; G06F 2221/2141

(57) ABSTRACT

A method of controlling access to a plurality of digital content items by a plurality of consumers on devices connected to a network, the method including: in a network browsing program on a processor connected to the network: enabling access for a first of the plurality of consumers to one or more of the plurality of digital content items via online computer software attached to the one or more of the plurality of digital content items; displaying an identifier of the one or more of the plurality of digital content items together with an image of a plurality of selectable alternatives for making payments to enable access to the one or more of the plurality of digital content items, wherein the alternatives are selected from paying at least one of money and attention; and in response to the first consumer selecting one of the alternatives, the online computer software verifying proof of work of the payment money and attention.

### CROSS-REFERENCE TO RELATED APPLICATIONS

This application claims priority to U.S. Provisional Patent Application Ser. No. 62/318,553, entitled “PAYWINDOWS” and filed Apr. 5, 2016, the disclosure of which is incorporated herein by reference in its entirety.

### FIELD OF INVENTION

The present system relates to valuation and purchase of digital content items and more particularly to unlocking access to selected digital content items in response to consumers paying money and/or paying attention to advertisement playback.

### BACKGROUND OF INVENTION

An immense amount and a wide variety of digital content items is accessible via the Internet and includes, for example, news articles, blogs, tweets, images, chats and the like. The digital content in various formats is provided by online publishers, such as, magazines, newspapers, periodicals, databases, and news and other information services. For a vast majority of these publications the content is provided free of charge or by paid subscription. This is achieved through the use of Paywalls, which are widely deployed on the Internet to prevent access to the digital content by unauthorized consumers.

Paywalls are online computer software that prevents consumers from accessing content hosted on the Internet webpages without a paid subscription. Some of the Paywalls allow or permit access to free of charge online content while withholding the permission to access the content paid for by subscriptions. Paywalls help bring in revenue for the protected online content by limiting access to paid subscribers.

Therefore, paywalls make it impossible to sell digital content items, i.e., articles, or charge a premium for articles describing sought after subject matter or written by sought after authors, etc., individually. Thus, consumers interested in articles in a specific subject, e.g., election coverage, sports or technology, from diverse sources are required to purchase monthly subscriptions to full publications, e.g., the New York Times, the Washington Post, the Wall Street Journal, etc. to satisfy their interests. Alternatively, non-premium articles on the same topics may be sought and obtained for free from online services like Yahoo and Google News.

Therefore, what is needed is a way to sell individual premium content articles online for a fee other than a full subscription to the publication.

However, if digital content items, such as news or sports articles, are made available for sale individually, valuation of such content becomes necessary. Apple's iTunes store offers two ways of valuating digital content items. Both ways provided are static. A price of a recorded music album is divided by the number of songs and each song is given this price. Another, more current, method is to price all songs in four price categories, so that most sought after songs are priced in the highest category and the least popular songs are offered for free. However, because the prices are not increased or lowered dynamically in response to changes in demand, profits cannot be maximized.

The drawbacks of static pricing are in that the consumers' interest fluctuates due to factors external to the consumers. For example, a rainy day may increase the demand for transportation services because more people use cabs when it rains. This causes the service to become scarcer, which raises its value to the consumers. U.S. Patent Publication No. 2013/0246207 describes a computer-based application for connecting consumers and transportation services. It discusses adjusting prices for the transportation services due to changes in external conditions by determining an amount of service requesters and an amount of available service providers at a given time and adjusting a price relative to a default price for the service based on the amount of service requesters.

The drawback of the referenced “surge pricing” is in that it addresses services having a physical limitation on the number of service providers, i.e., drivers. Because digital content items may be duplicated without limitation, notions of economical scarcity do not apply to the sales of digital content items. This discussion concerns only digital content items not affected by legal restrictions placed on such duplication by licensing agreements, digital rights management (DRM), and copyrights.

In addition to making cabs scarce during rain or plentiful on a sunny day, the weather or news events may influence the consumers to listen to nostalgic or more upbeat genres of music. During such surges of prices for various genres of songs may be adjusted dynamically to reflect the consumers' interest. Similarly, news events may influence consumers' interest. For example, when news of a future release of the latest Star Wars movie was announced, the consumers' interest in all things related to the Star Wars franchise, i.e., toys, games, books, articles, discussions, preview clips, has increased dramatically not only for the new content but also for the pre-existing content. It follows that while this heightened interest lasted, an objective market value of the content items related to Star Wars, was at its maximum price or very close to it.

Thus, what is needed is a way to dynamically, in real-time correct the prices of digital content items in accordance with consumers' interest to maximize profits.

### SUMMARY OF INVENTION

It is an object of the inventive system to enable access to individual discrete premium content items online for a payment other than a full subscription;

It is another object of the inventive system to enable access to individual discrete premium content items online for a payment selected from paying money, paying attention and/or a combination thereof;

It is still another object of the inventive system to provide a method and a system for dynamically varying prices of digital content items;

It is yet another object of the inventive system to provide a method and a system for correcting dynamically and in real-time the prices of digital content items in accordance with consumers' interest to maximize profits.

The present system enables valuating, offering for sale, and providing access to individual access protected digital content items in exchange for a payment. The digital content items may include news articles or stories of various interests accessible on the Internet. The access to the content items is provided when the consumers pay money or pay attention to one or more advertisements reflecting the valuation of the content items.

The valuating of the content items is achieved by (1) assigning to each content item a valuation function to calculate the value/price of the content item at any point during the content item's lifetime; and (2) adapting the assigned valuation function over the lifetime of its content item (starting at an initial offer for sale to an end of sales cycle) in accordance with market response, i.e., purchases and/or lack of purchases, which makes the adapted valuation function unique to the content item and its specific lifetime.

Provided is a method and a system of controlling access to a plurality of digital content items by a plurality of consumers on devices connected to a network, the method including: in a network browsing program on a processor connected to the network enabling access for a first of the plurality of consumers to one or more of the plurality of digital content items via online computer software attached to the one or more of the plurality of digital content items; displaying an identifier of the one or more of the plurality of digital content items together with an image of a plurality of selectable alternatives for making payments to enable access to the one or more of the plurality of digital content items, wherein the alternatives are selected from paying at least one of money and attention; and in response to the first consumer selecting one of the alternatives the online computer software verifying proof of work of the payment money and attention.

### BRIEF DESCRIPTION OF DRAWINGS

The invention is explained in further detail, and by way of example, with reference to the accompanying drawings wherein:

FIG. 1 is a diagram illustrating processing and database components in accordance with the present system;

FIG. 2a is a diagram illustrating general connectivity of external applications and internal processing and database components in accordance with the present system;

FIG. 2b is a diagram illustrating specific connectivity of external applications to a Secure Access layer in accordance with the present system;

FIG. 3 is a diagram illustrating online computer software Display Widget and Paywindows and a Paywindows lock in accordance with the present system;

FIG. 4 is a diagram illustrating an optional representation online of the Paywindows lock of FIG. 3 in accordance with the present system;

FIG. 5 is a flowchart diagram illustrating steps performed by online computer software Paywindows in accordance with the present system;

FIG. 6 is a diagram illustrating transmission of stories and advertisements to consumers' browsers in accordance with the present system;

FIG. 7 is a diagram illustrating the components making up one or more computing devices for performance of steps in accordance with the preferred embodiment.

### DETAILED DESCRIPTION OF INVENTION

The following is a description of illustrative embodiments that when taken in conjunction with the following drawings will demonstrate the above noted features and advantages, as well as further ones. In the description, for purposes of explanation rather than limitation, illustrative details are set forth such as architecture, interfaces, techniques, element attributes, etc. However, it will be apparent to those of ordinary skill in the art that other embodiments that depart from these details would still be understood to be within the scope of the appended claims. Moreover, for the purpose of clarity, detailed descriptions of well-known devices, tools, techniques and methods are omitted so as not to obscure the description of the present system. It should be expressly understood that the drawings are included for illustrative purposes and do not represent the scope of the present system. In the accompanying drawings, like reference numbers in different drawings may designate similar elements.

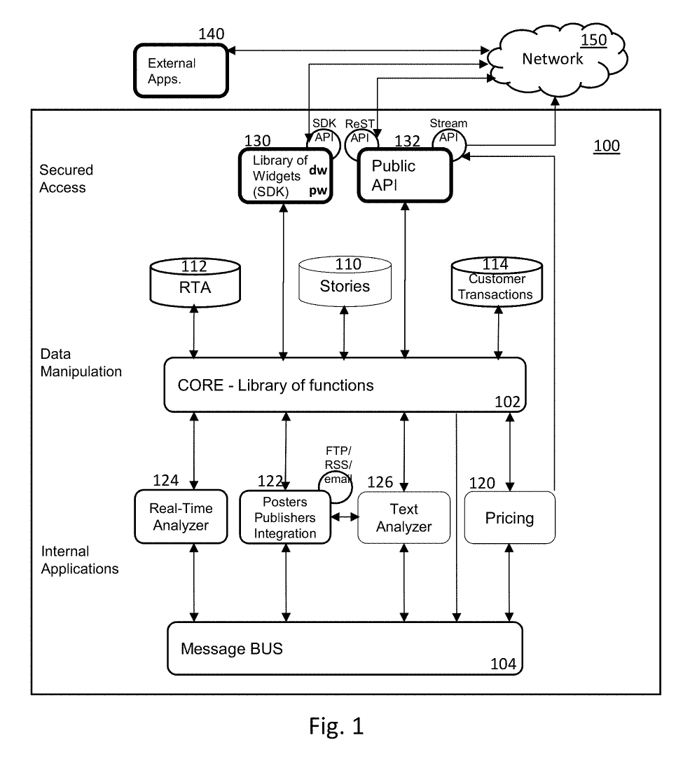

FIG. 1 illustrates network 150, e.g., the Internet, to which online External Applications 140 supporting consumer applications of the inventive system and server system 100 are connected. Server system 100 includes three logically arranged layers including Secured Access, Data Manipulation, and Internal Applications. The logically arranged layers are discussed here only for clarity of this description and the discussed separations of modules and databases are not required.

The Secured Access layer of server system 100 includes application program interface (API) for External Applications called Public API 132, which enables secure reception of digital content and other information via network 150. The Secured Access layer further includes software development kit (SDK) API 130 for securely supporting and delivering, e.g., below described online computer software, to External Applications 140.

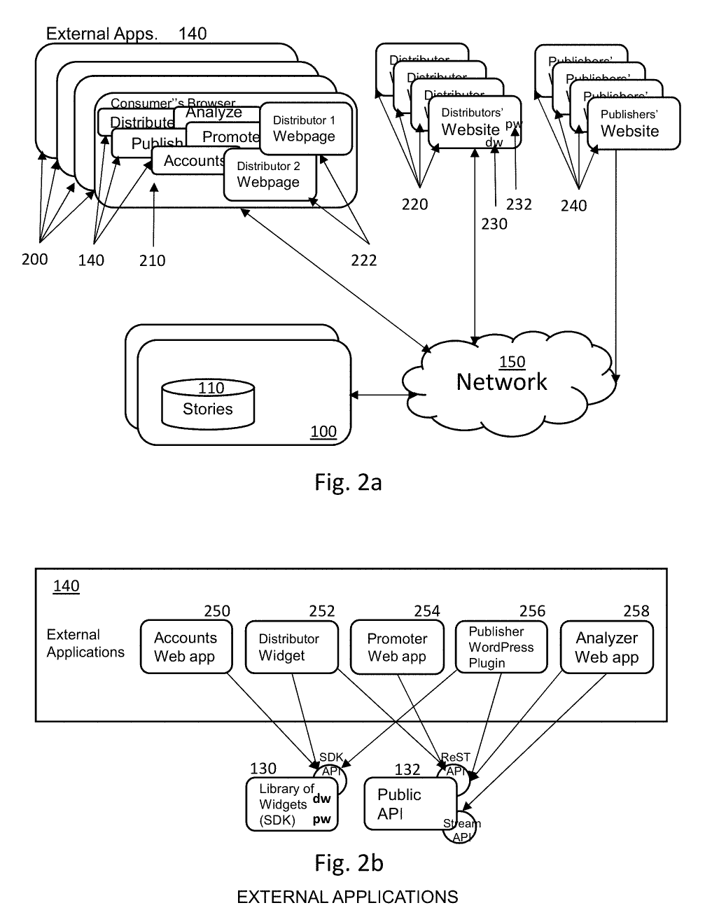

As illustrated in FIGS. 2a and 2b, External Applications 140 are executed by consumers using network browsing programs 210 on computing devices 200, e.g., computers, tablets, mobile devices, cell phones, etc., that are connected to network 150. Further, digital content items, which will be alternatively referred to as documents, stories, and articles, are provided to system 100 from websites and databases of content distributors 220, which may be also connected to network 150. Likewise, system 100 processes and calculates dynamic prices for the received digital content items and distributes the respective prices for display to consumers on webpages 222 on consumers' browsers 210. The webpages 222 are reflective of the digital content items on the respective distributors' websites 220. Exemplary applications of External Applications 140 may comprise the following:
a. Accounts application 250, for enabling consumers to register with system 100, i.e., open and maintain on-line accounts that enables purchase of credit, and subsequent use of the credit to purchase and access the content from webpages 222 displayed on computing devices 200.
b. Distribute application 252, for enabling formulation of online computer software referred to above and maintained in Library of Widgets 130. One code snippet of the online computer software called Display Widget (DW) 230 is used for receipt and display of dynamic prices from system 100, and is custom crafted for each distributor's website 220 in accordance with the registered consumer/distributor's requirements provided to Distributor application 252. Such requirements may include filters describing content favored for or inhibited from distribution, feeds from which the content is favored or inhibited for distribution. The formed code snippet may be placed on the registered distributor's website 220.

Another code snippet of the online computer software PW or Paywindows 232, is used for enabling consumers making a purchase of content, a choice between making a payment with their previously purchased credit and making the payment by watching one or more advertisements. The online computer software is loaded onto the distributor's website 220 for subsequent distribution to consumers' browsers 210 within webpages 240.
c. Promoter application 254, for enabling sponsors to select subject matter of or specific content items, which they are willing to sponsor and to specify price ranges at which they are willing to sponsor the selected subject matter. The sponsors are then enabled to provide links to the advertisements that they want to be seen by the consumers of the content. In addition, the sponsors can select authors, companies, and other parameters for positive and/or negative treatment, i.e., inclusion or exclusion from sponsorship.
d. Publisher application 256, for enabling registered consumers/publishers connected to system 100 via network 150 from computing devices 200 to author new articles and/or authorize conveyance of numerous content items to system 100, where these content items will be analyzed, dynamically priced and offered for sale on distributor's websites 220. The registered consumers/publishers such as seasoned journalists, groups of journalists, journalists' or writers' representatives or employers, e.g., newspapers, magazines, or online distributors may have existing digital content items, which can be directed to system 100, e.g., via (Representational State Transfer) ReST API of Public API 132.
e. Analyzer application 258 enables consumers/publishers to analyze behavior of, and other information about the published stories, e.g., how often each story is purchased, at what price, in what geographic location, by whom, etc., this analysis will be further described below.

Additional External Applications 140 are provided, e.g., to enable individual consumers to contribute or write original content items, such as opinion articles and offer them for sale, using software plugins, e.g., open-source content management system like WordPress, that enables composition of a text story and inclusion of media files. In this case, the consumers/writers will be asked to provide a synopsis; profiles of websites on which the article should or should not be published; and a proposed lifetime for the article and optionally at least a minimum price below which the article should not be sold. Moreover, the text of the original content items may be analyzed, in a manner described below, to identify keywords on which basis attributes are established. The attributes express the content items' class/domain and other characteristics.

Returning now to FIG. 1, server system 100 further includes a Data Manipulation layer comprising Core module 102 and databases described below, some of which are managed, supported, and accessed using a comprehensive collection of library functions comprised in Core module 102. Processing calls requesting execution of these library functions are made from blocks in Internal Applications layer, which communicate with one another and Core module 102 via bus 104.

The databases in the Data Manipulation layer include at least Stories database 110, real time analysis (RTA) database 112, and Customer Transactions database 114. Stories database 110 comprises text based as well as non-text content items, e.g., audio, video, images, software, mixed media, etc., and respective metadata received, as discussed above from External Applications 140 and content distributors. RTA database 112 stores information regarding the published stories and purchases made by the consumers, i.e., what stories were purchased, when, and for how much. This information is also called clicks because purchases over the Internet are made on computers using mouse devices to make clicks indicating purchases. Customer Transactions database 114 records activities performed by the registered consumers engaging with External Applications 140, e.g., activities relating to registration, purchase of credit, authoring of stories to be added to Stories database 110, purchase of access to stories and other. Additional databases are discussed below.

It is understood by these skilled in the art that while in this description the textual and non-textual content is described as being managed in a single database, for speed and/or ease of access separate databases may be used specifically for separating text based and media content.

The Internal Applications layer includes Integrations block 122, which manages integration of the content items received, as discussed above, from Publishers' 240 (FIG. 2a), e.g., via feeds in various formats including file transfer protocol (FTP) and Rich Site Summary (RSS) formats and/or via email, into Stories database 110. The content of each of the received content items is processed by Text Analyzer 126 to identify the keywords that are used to define attributes. The attributes may then be used to express the content items' class/domain. Valuation Analyzer 120 derives dynamic, objective market value (price) for the valuation functions of the respective content items for the duration of the lifetimes, i.e., period during which the content item is offered for sale.

Moreover, at predetermined intervals and/or upon request, Valuation Analyzer 120 streams the dynamic prices in real-time via streaming API of Public API 132 to network 150. In addition, as stated above, Valuation Analyzer 120 processes content entered by the registered consumer in Publish Application 256.

As discussed, upon receipt at the Distributors' websites 220 (FIG. 2a), the price is displayed by online computer software DW 230 (FIG. 2a) on External Applications 140 as an offer to sell access to the digital content. Purchase of the content is achieved through online computer software Paywindows 232 (FIG. 2a), which offers consumers a choice between making a payment in currency or by watching an advertisement. When Paywindows 232 determines that either payment option is completed, access to the purchased content is enabled.

The Internal Applications layer further includes RTA block 124 that monitors relevant event transactions on message bus 104 and when such event transactions are detected, they are recorded in RTA database 112. As mentioned, RTA block 124 also processes events communicated by Analyze Application 258 (FIG. 2b). All events and transactions affecting respective stories that are processed by RTA block 124 are stored in RTA database 112.

It will be clear to these skilled in the art that Stories and RTA databases 110 and 112 are document-oriented databases, so database packages such as MongoDB, Cassandra, and HBase, for example, can be used for their implementation. For consumers' transactions database 114 a Structured Query Language (SQL) database may be used.

### Text Analyzer and Valuation

As discussed above with reference to External Applications 140, the digital content items comprise characteristics of varying importance or significance with respect to the objective market value of the content item. This importance or significance is derived from the content by Text Analyzer 126. Then Pricing module 120 attaches or assigns corresponding valuation (pricing) functions to each of the content items. A determination of correspondence between the valuation functions and the content items is made on the basis of the derived importance or significance of the content items' characteristics.

The valuation functions may be pre-defined by experts most familiar with consumer behavior related to consumption of stories in the various specific classes/domains and the lifetime or sustainability of the consumption. For example, experts in on-line sales of various types of literature, who are familiar with price premiums placed on various authors and literary genres, may be considered fit to formulate the default valuation functions for poems. Alternatively or in combination with the experts, expert knowledge may be harnessed from on-line databases and websites like Wikipedia.org and used to formulate or pre-define valuation functions, e.g., corresponding to specific known classes/domains.

In addition, after some initial period system 100 (FIG. 1) will collect and archive numerous valuation functions associated with stories having specific characteristics, and which valuation functions have been previously adapted to market behavior of the consumers. These previously adapted valuation functions can be assigned to newly received stories based on closeness or similarity of the old and new stories' characteristics.

### Paywindows

As discussed above, the Paywalls prohibit access to all protected content items. This means that access to individual protected content items is prohibited, thereby greatly limiting the publishers' revenue from sales of the individual protected content items to numerous non-subscribing consumers. Additionally, any advertising revenue due to sponsorship of sale of the individual protected content items is also lost. Non-subscribing consumers are very interested in consumption of a limited number of content items from each of multiplicity of varied publishers, without having to subscribe to each and every publication. That is because the cost of such subscriptions quickly becomes too burdensome or disproportionate to the value of a few articles that the consumers may want to read.

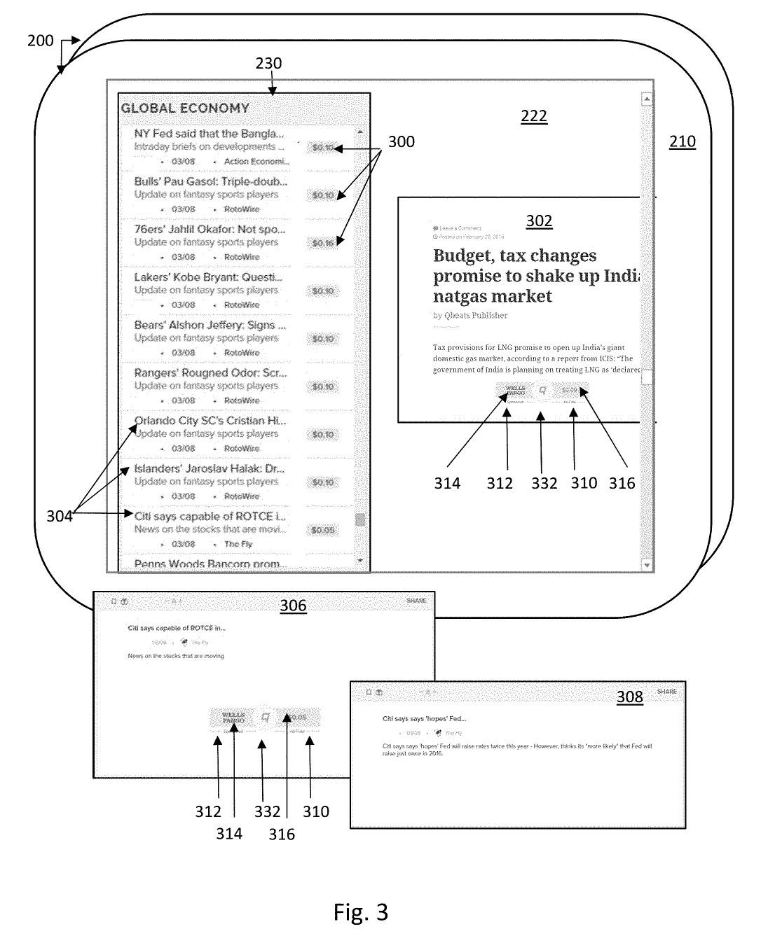

The present inventive system corrects the above-described shortcomings of the Paywalls. Instead of controlling access to all protected content, access to each, individual content item or story is controlled by the online computer software Paywindows 232. As illustrated in FIG. 3 consumers using network browsing programs 210 on any type of computing devices 200, e.g., mobile phones, laptop computers, etc., may open webpages 222 reflecting publishers' websites 240 (FIG. 2a) and including on webpages 222 online computer software DW 230.

DW 230 displays a lists of story labels 304, e.g., an initial line of text or a first sentence; a hidden from view unique identifier for each of the listed stories; and respective prices 300 corresponding to the stories. The unique identifiers relate to the content items or stories that were processed and assigned valuation functions as discussed above. Prices 300 indicate a cost of access to the respective stories as dynamically determined for each of the stories at any point in time by the assigned valuation functions. Prices 300 are continuously updated in the displayed lists created by DW 230 throughout the stories' commercially viable lifetime.

When one of labels 304 is selected, e.g., by the consumers clicking on or selecting labels 304, the unique identifier is used to locate the selected content item identified by labels 304 in database 110 (FIG. 2a) or in publishers' website 240 (FIG. 2a) database and serve or send the selected content item to the webpage 222 for display on browser 210. However, prior to displaying the selected content item, if system 100 determines that the selected content item having the unique identifier also has an assigned valuation functions, then:
1) The Paywindows 232 (FIGS. 2a and 2b) is attached to the selected story 306 to prohibit access to or full display of the selected content item until proof of work or proof of payment is presented to Paywindows 232. Similarly, Paywindows 232 can be attached to content items that were not selected from the list created by DW 230. Instead Paywindows 232 can be attached to any content item having a price. An example of this is story 302;
2) An example of the selected content item is story 306, which similar to story 302 is displayed with lock 332 generated by Paywindows 232, it is well understood by these skilled in the art that representations of lock 332 can have any different form and be located, i.e., displayed in any other position, and that there is no requirement of displaying lock 332 together with the content items as with stories 302 and 306; and
3) Upon manipulation of lock 332 on story 306 and presentation and acceptance of the proof of work in Paywindows 232 attached to story 306, full story 308 is unlocked and made accessible.

Thus, Paywindows 232 is a code snippet which is automatically added to content items before they are displayed, and facilitates locking of access to content items or stories 302 and 306 individually before they are displayed. The unlocking of the content items is achieved, for example, by the consumers paying money and/or paying attention to advertisements and may, for example, give the consumer an ability to read/copy/add comments to the individual content item, e.g., story 308.

The payment is perfected by manipulating, e.g., clicking on or touching panes 310 and 312 of lock 332, which will alert system 100 (FIG. 1) to initiate processing to collect one of a number of different manners of payment. For example, a signal generated by Paywindows 232 in response to manipulation of pane 310 will alert Accounts application 250 (FIG. 2b) to charge amount 316 displayed on pane 310 of stories 302 or 306 at the time of manipulation. A return signal, indicating proof of work or that the payment was deducted from Accounts application 250 will trigger Paywindows 232 to unlock access to stories 302 or 306.

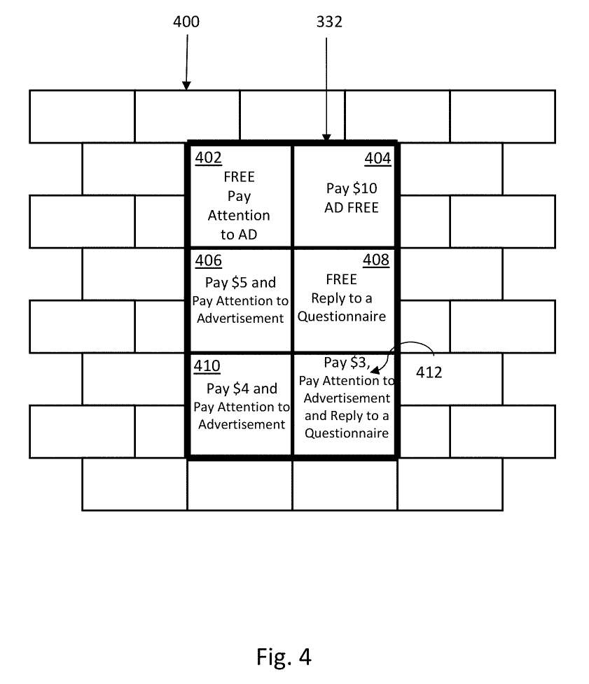

Additional payment methods may include, e.g., paying attention to an advertisement; and paying attention and responding to questioners and surveys as will be described below with reference to FIG. 4. In response to manipulation, e.g., clicking on or touching, of pane 312, Paywindows 232 will generate a signal to alert Promoter application 256 (FIG. 2b) or to request advertiser 314 identified on pane 312 (in the presented example, “Wells Fargo”) to serve, one or few advertisements having a pre-determined value corresponding to amount 316 displayed on pane 310 at the time of manipulation by the consumer.

The specific advertisement, including at least one of a video, and image, a banner, a survey, and questionnaire is served or delivered to webpages 222 and presented to the consumer. As part of the presentation, e.g., after three quarters of the advertisement is played, the consumer may be shown a random combination of numbers and/or letters generated by Paywindows 232. Correct identification of the combination by the consumer can then be used as the proof of work. Thus, an example of proof of work of paying attention to the served advertisement, the consumer may be asked to re-enter the random combination shown as part of the advertisement. As with regard to questioners and surveys a predetermined number of answered questions can serve as the proof of work. As stated above, provision of the proof of work to Paywindows 232 triggers unlocking of access to the content item, e.g., story 308, for the consumer.

It will be well understood by these skilled in the art that other appropriate proofs of work including unique identifiers, tokens, and any other may be used. It will be further understood by these skilled in the art that panes 310 and 312 are used as an example of acceptable manners or methods of payment and that any number of panes and respective methods can be used. An example of this is shown in FIG. 4, where Paywall 400 is breached by Paywindows 232 (FIG. 2a), which in this example, generated six panes 402-412. As illustrated, panes 402 and 404 are similar to panes 310, 312 (FIG. 3), they require paying money and/or paying attention to an advertisement. Panes 406 and 410 enable payments of progressively lesser amounts of money but include payment of attention to watch appropriately crafted advertisements that total to a combined value that equals the value of the content item at the moment of selection. Pane 408 allows access to the content in exchange for paying attention to a questionnaire and providing answers. A predetermined number of these answers, or an answer to a specific question can also be used as proof of work. Pane 412 combines the three discussed payment options.

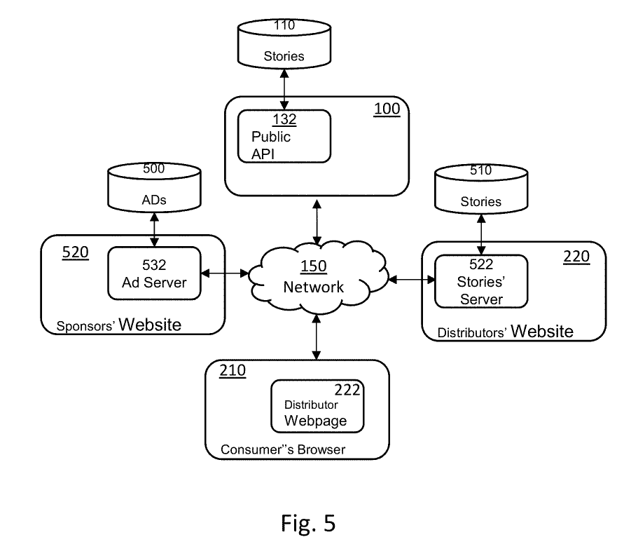

Additionally, Paywindows 232 solves network traffic issues that, as illustrated in FIG. 5, arise when access to individual content items is protected by serving or sending the content items to the webpage only after they are purchased. It is important to recognize that without Paywindows 232 some shortened version of the stories needs to be served or sent for viewing and selecting by the consumers. Then the full version must be re-sent after payment to the consumers' browsers 210 from Distributors' databases 510 by, for example, Distributors' story servers 522 or from system 100 stories database 110 by Public API 132. Also, additional network traffic is generated when the ads are served or delivered to the consumers' browsers 210 from external sponsors' databases 500 by ad servers 532. In a system processing hundreds of thousands even millions of request for access, transmissions of stories and advertisements numbering in multiples of these requests will be initiated.

Paywindows 232 (FIG. 2a) solves this network traffic issue by sending stories only once. If for example, only a portion of a message 302 and 306 (FIG. 3) is provided for display with lock 332 (FIG. 3) the full story 308 will have to be re-sent after a payment is made. Thus, by sending a full story and preventing access to it by Paywindows 232 and simply unlocking the access once a payment is made, eliminates at least two network transmissions, i.e., request for the full story one way and the full story the other way.

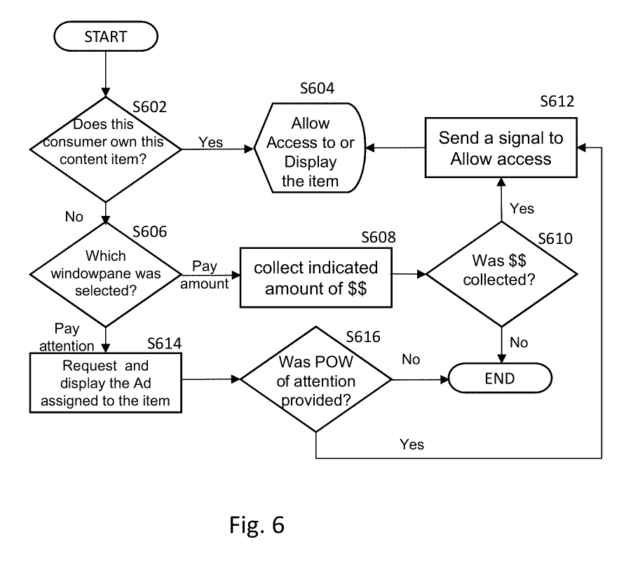

FIG. 6 illustrates steps providing access to the selected protected content items identified by labels 304 (FIG. 2a), these steps will be described with reference to FIGS. 3 and 4. The processing is initiated when consumers request access to one of the content items by clicking on or selecting labels 304 in the list provided by online computer software DW 230. If Paywindows 232 (FIG. 2a) is attached to the selected story, at step S602 Paywindows 232 determines if the selected content item was previously purchased by the consumer. This is achieved by requesting system 100 (FIG. 1) to verify ownership using the consumer's and story's ids and Accounts application 250 (FIG. 2a) and customer transactions database 114 (FIG. 1). If the content item is determined to be pre-owned, at step S604 access to the selected content item is allowed without requiring a payment.

At step S606 Paywindows 232 (FIG. 2a) determines which pane 310, 312 (FIG. 3); 402-412 (FIG. 4) was selected.
a. If the pane specifying a payment of some specified amount was selected, at step

S608, a request is made to system 100 (FIG. 1) to collect the specified amount from the consumer. If at step S610 it is determined that the specified amount is not collected, the processing terminates and access to the content item is not allowed. If on the other hand at step S610 it is determined that the specified amount was collected, e.g., by receiving a confirming signal from system 100, processing continues at step S612.
b. If the pane specifying payment of attention was selected, at step S614 ad server 532 (FIG. 5) at sponsor's website 520 (FIG. 5) is requested to serve or stream the specified advertisement, e.g., from ads database 500 (FIG. 5). The advertisement is received and displayed to the consumer. At step S616 Paywindows 232 determines “proof of work” of paying attention to the ad. If it is determined that attention was not paid to the served advertisement identified in the selected pane, the processing is terminated and access to the content item is not allowed. If, on the other hand, at step S616 “proof of work” of watching the ad is verified, processing is continued at step S612.

At step S612, after verifying proof of payment, i.e., of money and/or attention, Paywindows 232 enables the consumer, making the request, to access the selected content item. These skilled in the art will readily understand how to use combinations of payment options indicated in FIG. 4 as well as how to enable and disable readability of a whole or a part of a content item.

It is further noted that panes of the lock 332 (FIG. 4) can also be used to enable requests for automatic purchase including, e.g., “Purchase when the price reaches/falls to $10”; “Purchase when the story is purchased by 20 other consumers”; “Purchase when ‘Joe’ purchases”; etc.

### Processor

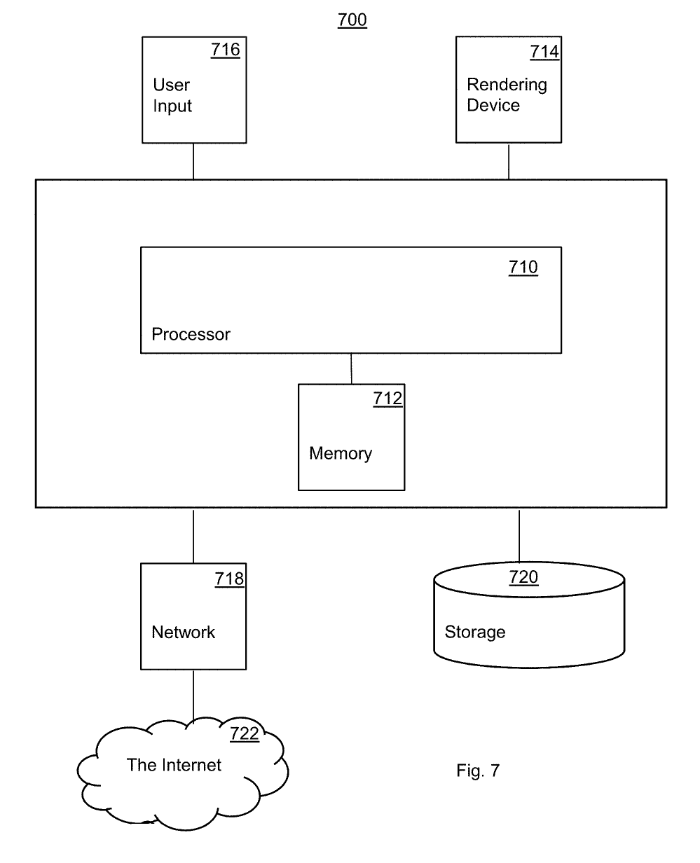

FIG. 7 shows a system 700, which represents an example of a computing device utilized to implement and execute the various modules described above with reference io to the External Applications; Secured Access; Data Manipulation; and Internal Applications layers and any other programs discussed with reference to the Figs. One or more systems 700 may be used to execute the above-discussed modules, programs, and maintain the databases. Similarly, it will be apparent to these skilled in the art that each of these programs may be subdivided into separate discrete units of programming code. Any bundling of these units is done to simplify the narrative of this discussion.

The system 700 includes a processor 710 operationally coupled to a memory 712, an optional rendering device 714, such as one or more of a display terminals, one or more user input devices 716, a network interface 718 connectable via wired or wireless means to a network 722, e.g., the Internet, and optionally a local storage 720. The user input 716 may include a keyboard, mouse or other devices including touch sensitive displays communicating with the processor 710 via any type of link, such as a wired or wireless link. The user input device 716 is operable for interacting with the processor 710 including interaction within a paradigm of a UI such as a GUI and/or other elements of the present system, such as to enable web browsing, content selection, such as provided by left and right clicking on a device, a mouse-over, pop-up menu, radio button, etc., such as provided by user interaction with a computer mouse, etc., as may be readily appreciated by a person of ordinary skill in the art. Thus it is clear that the processor 710, memory 712, optional rendering device 714, user input device 716, and network adapter 718 may be portions of a computer system or other device.

The storage 720 may be any fixed or removable computer-readable medium, e.g., ROM and RAM, CD-ROM, hard drives, or memory cards. Any medium known or developed that may store and/or transmit information suitable for use with the computer system may be used as the computer-readable medium. Such computer-readable medium may be used to store all the discussed programs for execution by processor 710. The network adapter 718 should be understood to include further network connections to other user devices, systems, e.g., routers, modems, etc. While not shown for purposes of simplifying the description, it is readily appreciated that the network adapter 718 may include an operable interconnection between networked processors, which may host websites.

### Provisions

While the present system has been described with reference to exemplary embodiments, it should also be appreciated that numerous modifications and alternative embodiments may be devised by those having ordinary skill in the art without departing from the broader and intended spirit and scope of the present system as set forth in the claims that follow.

The section headings included herein are intended to facilitate a review but are not intended to limit the scope of the present system. Accordingly, the specification and drawings are to be regarded in an illustrative manner and are not intended to limit the scope of the appended claims. In interpreting the appended claims, it should be understood that:
a. the word “comprising” does not exclude the presence of other elements or acts than those listed in a given claim;
b. the word “a” or “an” preceding an element does not exclude the presence of a plurality of such elements;
c. any reference signs in the claims do not limit their scope;
d. several “means” may be represented by the same item or hardware or software implemented structure or function;
e. any of the disclosed elements may be comprised of hardware portions (e.g., including discrete and integrated electronic circuitry), software portions (e.g., computer programming), and any combination thereof;
f. hardware portions may be comprised of one or both of analog and digital to portions;
g. any of the disclosed devices, portions thereof, acts, etc., may be combined together or separated into further portions, acts, etc., unless specifically stated otherwise;
h. no specific sequence of acts or steps is intended to be required including an is order of acts or steps indicated within a flow diagram; and
i. the term “plurality of” an element includes two or more of the claimed element, and does not imply any particular range of number of elements; that is, a plurality of elements may be as few as two elements, and may include an immeasurable number of elements.

What is claimed is:

1. A method of controlling access to a plurality of digital content items by a plurality of consumers on devices connected to a network, the method comprising acts of:
in a network browsing program on a processor connected to the network:
enabling access for a first of the plurality of consumers to one or more of the plurality of digital content items via online computer software attached to the one or more of the plurality of digital content items;
displaying an identifier of the one or more of the plurality of digital content items together with an image of a plurality of selectable alternatives for making payments to enable access to the one or more of the plurality of digital content items, wherein the alternatives are selected from paying at least one of money and attention; and
in response to the first consumer selecting one of the alternatives the online computer software verifying proof of work of the payment money and attention.

2. The method of claim 1, further comprising an act of disabling access to one or more of the plurality of digital content items.

3. The method of claim 2, wherein the access is disabled by attaching the online computer software to the one or more of the plurality of digital content items.

4. The method of claim 1, wherein the access is enabled in response to the proof of work verification.

5. The method of claim 1, wherein the payment of attention is determined for any of watching advertisements, responding to questioners, and filling out surveys.

6. The method of claim 5, wherein selected one or more answers in the questioners and surveys is used as proof of work.

7. The method of claim 5, wherein providing information displayed in the advertisement after viewing the advertisement is used as proof of work.

8. The method of claim 5, wherein a confirmation of transfer of money is used as proof of work.

9. The method of claim 1, wherein the plurality of selectable alternatives includes any of an amount of payment, one or more advertisements, one or more surveys, one or more questioners.

10. The method of claim 1, wherein a monetary value of the plurality of selectable alternatives is the same.

11. The method of claim 1, wherein the network comprises the Internet, each of the plurality of content items comprises metadata and data including at least one of text, audio, video, and still images.

12. The method of claim 9, wherein the plurality of selectable alternatives further includes requests for automatic purchase of one of the plurality of content items selected from any of requesting a purchase when a monetary value reaches above, falls below or is equal to a predefined amount, when interest in the content item reaches a predefined level, when the content item is purchased by a known customer.

13. A computer program product for controlling access to a plurality of digital content items by a plurality of consumers on devices connected to a network, the computer program product tangibly embodied on a non-transitory computer readable medium and including instructions for causing a processor connected to the network to perform acts comprising:
enabling access for a first of the plurality of consumers to one or more of the plurality of digital content items via online computer software attached to the one or more of the plurality of digital content items;
displaying an identifier of the one or more of the plurality of digital content items together with an image of a plurality of selectable alternatives for making payments to enable access to the one or more of the plurality of digital content items, wherein the alternatives are selected from paying at least one of money and attention; and
in response to the first consumer selecting one of the alternatives, the online computer software verifying proof of work of the payment money and attention.
